(19) United States
(12) Patent Application Publication
(10) Pub. No.: US 2009/0260189 A1
(43) Pub. Date: Oct. 22, 2009

(54) Grip Designed for a Handle and Method of Making The Same

(76) Inventor: Leo Jaw, Ta Tu Hsiang (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/103,736

(22) Filed: Apr. 16, 2008

(51) Int. Cl. B25G 1/00; B23P 11/00; B25G 1/10; A63B 53/14

(52) U.S. Cl. 16/421; 29/592; 29/428; 473/300

(57) ABSTRACT

A grip designed for a handle that has a quality of unidirectional extendibility and that is extended in a direction in accordance with a direction of extendibility for wrapping the handle. A method for making a grip designed for a handle includes preparing a sheet that has a quality of unidirectional extendibility; trimming the grip from the sheet; and extending the grip in a direction in accordance with a direction of extendibility for wrapping the handle.

### BACKGROUND OF THE INVENTION

1. Field of the Invention

The present invention relates to a grip designed for a handle and its method of making, in particular to a grip that can extend easily in the direction of wrapping on a handle.

2. Description of the Related Art

China Pat. No. CN2640544 discloses a handle protecting belt including a first strap 12 and a second strap 14 made of rubber material, and a third strap 19 made of polyurethanes (PU) or EVA, depending upon whether the handle protecting belt is intended to be held in comfort or whether the handle protecting belt is intended to be provided with better shock-absorbing quality.

While these straps are made of material that has extendibility, these straps do not form the protecting belt that can be easily pulled to wrap onto a handle. As a result, it is thus desirable to provide a belt that can be more easily wrapped onto a handle or an article for which it is designed.

The present invention is, therefore, intended to obviate or at least alleviate the problems encountered in the prior art.

### SUMMARY OF THE INVENTION

Accordingly, the present invention is to disclose a grip designed for a handle that has a quality of unidirectional extendibility and that is extended in a direction in accordance with a direction of extendibility for wrapping the handle.

In one embodiment, the grip is extended circumferentially around the handle and makes a left side and a right side thereof have a connection therebetween such that the connection creates a seam line in accordance with a lengthwise direction of a handle.

In another embodiment, one of the left side and the right side is extend circumferentially upward around the handle and the other of the left side and the right side is extended circumferentially downward around the handle such that the grip is spirally formed along the lengthwise direction of the handle.

Accordingly, the present invention is to disclose a method for making a grip designed for a handle and the method includes preparing a sheet that has a quality of unidirectional extendibility; trimming the grip from the sheet with the grip including a first side and a second side; and extending the first and the second sides in a direction in accordance with a direction of extendibility for wrapping the handle.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

### BRIEF DESCRIPTION OF THE DRAWINGS

For the present disclosure to be easily understood and readily practiced, the present disclosure will now be described in conjunction with the following figures, wherein;

FIG. 1 is a process of making a grip in accordance with a first embodiment of the present invention.

FIG. 2 shows a sheet adapted to be used for making the grip.

FIG. 3 shows one grip of the first embodiment of the present invention.

FIG. 4 shows the grip in FIG. 3 wrapped onto a handle.

FIG. 5 is a process of making a grip in accordance with a second embodiment of the present invention.

FIG. 6 is an illustrative view showing how the grip of the second embodiment of the present invention is formed from the sheet in FIG. 2.

FIG. 7 shows one grip of the second embodiment of the present invention.

FIG. 8 shows the grip in FIG. 7 wrapped onto a handle.

FIG. 9 is a process of making a grip in accordance with a third embodiment of the present invention.

FIG. 10 is an illustrative view showing how the grip of the third embodiment of the present invention is formed from the sheet in FIG. 2.

FIG. 11 shows one grip of the third embodiment of the present invention.

### DETAILED DESCRIPTION OF THE PREFERRED EMBODIMENT

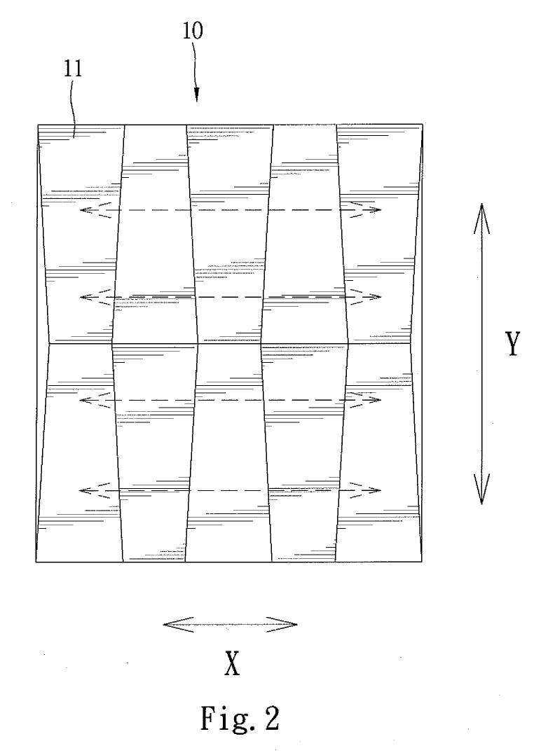

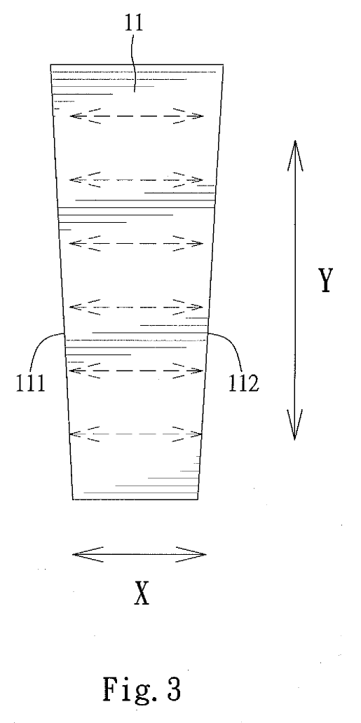

Referring to FIGS. 2 and 3, a grip 11 designed for a handle is trimmed from a sheet 10 that has a quality of unidirectional extendibility. Preferably, the sheet 10 is made from natural/synthetic leather, as it is understood that this material has a good quality of unidirectional extendibility.

In this embodiment, the sheet 10 has the extendibility in accordance with a double-headed arrow X (as indicated by phantom arrows) and, the grip 11 has a left side 111 that can be stretched in accordance with the left arrow head of the double-headed arrow X and a right side 114 that can be stretched in accordance with the right arrow head of the double-headed arrow X. It should be understood the term “right”, “left” and “X” used herein have reference only to the structure shown in the drawings.

FIG. 2 also shows that a plurality of grips 11 can be produced in one sheet 10, for instance, 10 grips here.

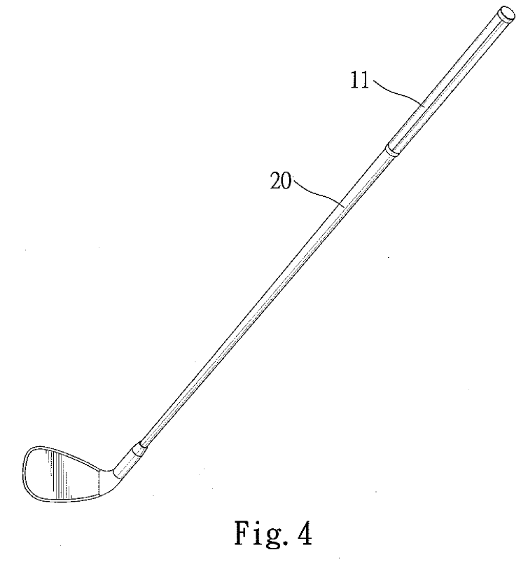

FIG. 4 shows that when grip 11 is wrapped onto a handle 20, the grip 11 is extended in a direction in accordance with a direction of extendibility, and the left side 111 and the right side 112 are extended circumferentially around the handle 20 to make a connection therebetween, such that the connection creates a seam line in accordance with a lengthwise direction of a handle 20.

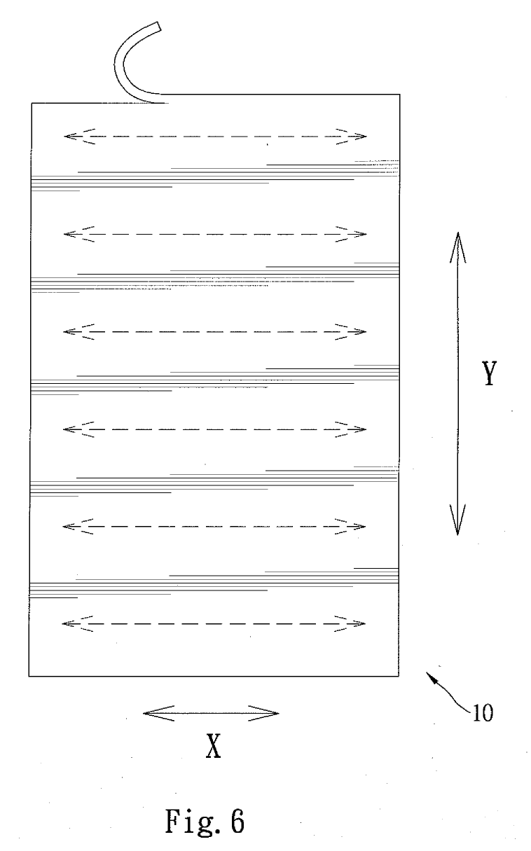

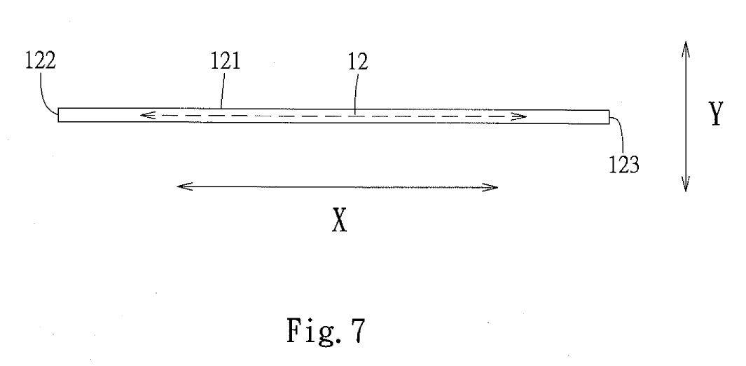

Referring to FIGS. 6 and 7, a grip 12 designed for a handle in accordance with a second embodiment of the present invention is trimmed from the sheet 10 in one of the directions in accordance with an arrow head of the double-headed arrow X. The grip 12 has two parallel sides 121 extending in a direction in accordance with the double-headed arrow X and a left side 122 and a right side 123 interconnecting the parallel sides 121, respectively. Preferably, the sides 121 are relatively longer than the left side 122 and the right side 123.

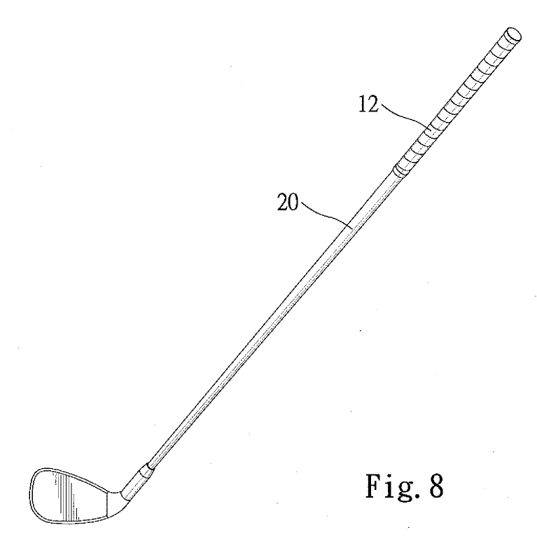

FIG. 8 shows that when the grip 12 is wrapped onto the handle 20, the strip 12 is extended in a direction in accordance with a direction of extendibility and one of the sides 122 and 123 is extended circumferentially upward and the other of the sides 122 and 123 circumferentially downward such that the grip 12 is spirally formed along the lengthwise direction of the handle 20.

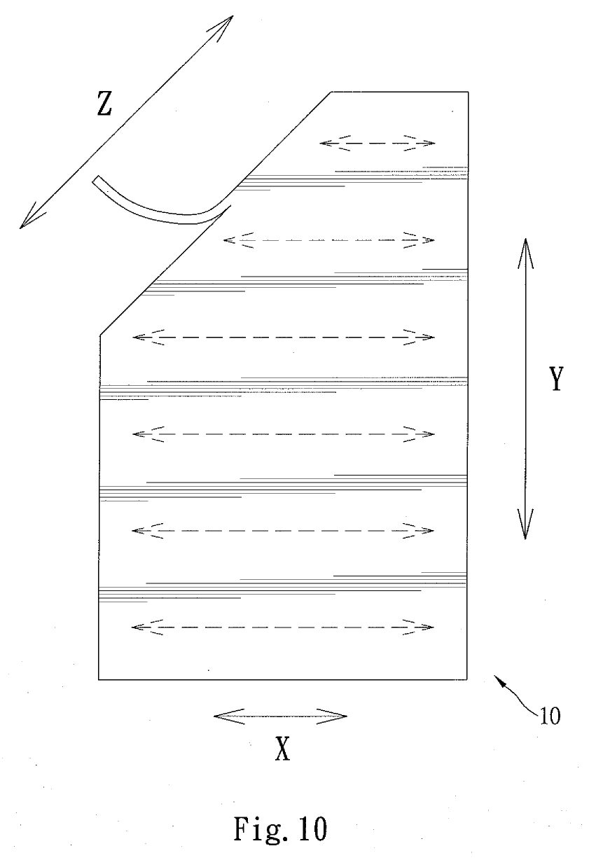

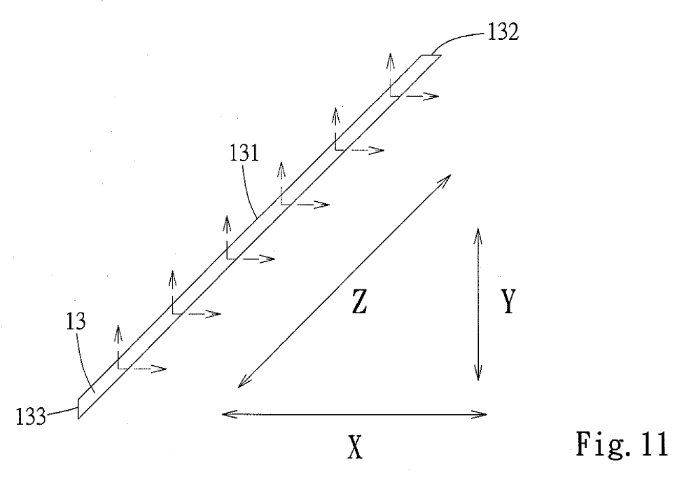

Referring to FIGS. 10 and 11, a grip 13 designed for a handle in accordance with a third embodiment of the present invention is trimmed from the sheet 10 in one of the directions in accordance with an arrow head of the double-headed arrow Z. The grip 13 has two parallel sides 131 extending in accordance with the double-headed arrow Z and a right side 132 and a left side 133 interconnecting the parallel sides 131, respectively. Preferably, the sides 131 are relatively longer than the right side 132 and the left side 133.

In this embodiment, the arrow Z cooperates with the arrow X to define an angle ranging from 30°-60°. Preferably, this angle is 45°. Further, the arrow Z cooperates with arrow Y to define an angle ranging from 30°-60°. Preferably, this angle is 45°. Further, the arrow X cooperates with the arrow Y to define an angle of 90°.

By trimming the grip 13 in this manner, the grip 13 has a quality of extendibility in accordance with the double-headed arrow X as well as a quality of extendibility in accordance with the double-headed arrow Y (as indicated by phantom arrows).

When the grip 13 is to be wrapped on the handle 20, the strip 13 is extended in a direction in accordance with a direction of extendibility and one of the sides 132 and 133 is extended circumferentially upward and the other of the sides 132 and 133 is extended circumferentially downward such that the grip 13 is spirally formed along the lengthwise direction of the handle 20.

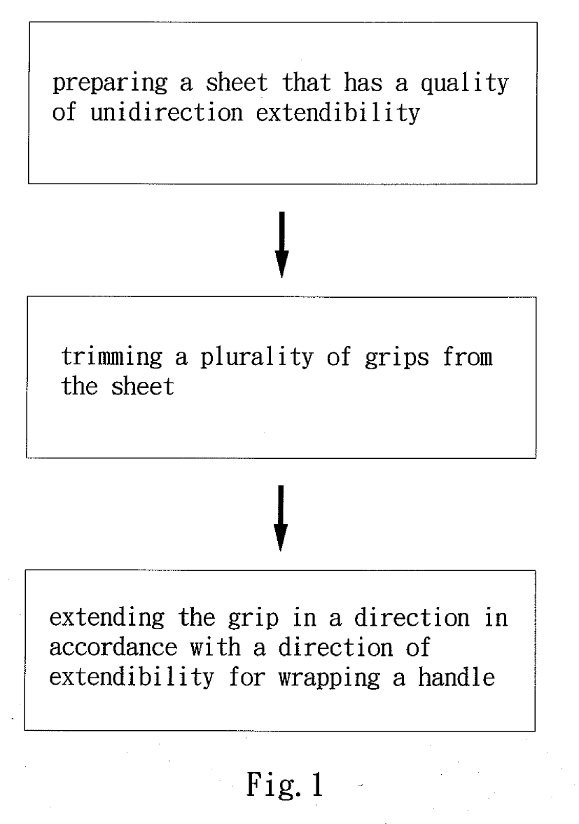

Referring now to FIG. 1, a process of making a grip 11 designed for a handle 20 in accordance with a first embodiment of the present invention includes preparing a sheet 10 that has a quality of unidirectional extendibility; trimming the grip 11 from the sheet 10; and extending the grip 11 in a direction in accordance with a direction of extendibility to make a left side and right side 111 and 112 thereof have a connection therebetween such that the connection creates a seam line in accordance with the lengthwise direction of the handle 20.

Preferably, the sheet 10 is made from natural/synthetic leather and a plurality of grips 11 can be trimmed from one sheet 10.

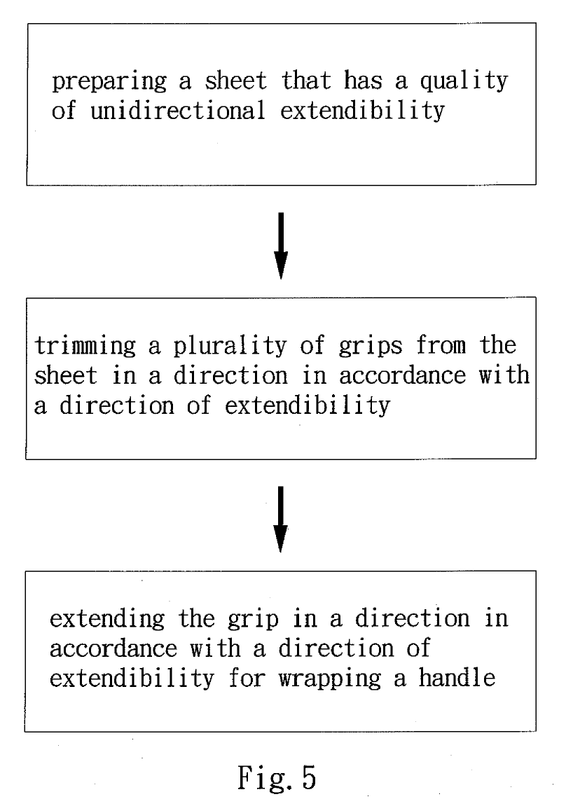

Referring to FIG. 5, a process of making a grip 12 designed for a handle 20 in accordance with a second embodiment of the present invention includes preparing a sheet 10 that has a quality of unidirectional extendibility; trimming the grip 12 in a direction in accordance with a direction of extendibility; and then extending the grip 12 in a direction in accordance with a direction of extendibility and one of the sides 122 and 123 thereof upward and the other of the sides 122 and 123 downward such that the grip 12 is spirally formed along the lengthwise direction of the handle 20.

Preferably, the sheet 10 is made from natural/synthetic leather and a plurality of grips 12 can be trimmed from one sheet 10.

Preferably, the grip 12 has two parallel sides 121 in accordance with the direction of trim and the sides 121 are relatively longer than the left side 122 and the right side 123.

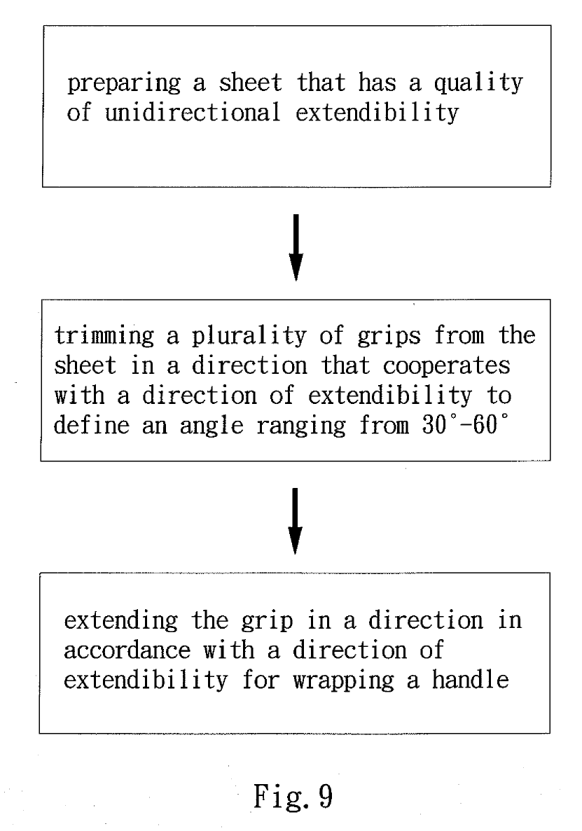

Referring to FIG. 9, a process of making a grip 13 designed for a handle 20 in accordance with a third embodiment of the present invention includes preparing a sheet 10 that has a quality of unidirectional extendibility; trimming the grip 13 in a direction that cooperates with a direction of extendibility to define an angle ranging from 30°-60°; and extending the grip 13 in a direction in accordance with a direction of extendibility and one of the sides 132 and 133 thereof upward and the other of the sides downward such that the grip 13 is spirally formed along the lengthwise direction of the handle 20.

Preferably, the sheet 10 is made from natural/synthetic leather and a plurality of grips 13 can be trimmed from one sheet 10.

Preferably, the grip 13 has two parallel sides 131 in accordance with the direction of trim and the sides 131 are relatively longer than the right side 132 and the left side 133.

While the specific embodiments have been illustrated and described, numerous modifications come to mind without significantly departing from the spirit of invention and the scope of invention is only limited by the scope of accompanying claims.

What is claimed is:

1. A grip designed for a handle comprising:
a grip trimmed from a sheet, with the sheet having a unidirectional extendibility, and the grip being formed with unidirectional extendibility; and
wherein the grip is extended in a direction in accordance with a direction of extendibility for wrapping the handle.

2. The grip as claimed in claim 1 wherein the grip is trimmed in a direction in accordance with a direction of extendibility.

3. The grip as claimed in claim 1 wherein the grip is trimmed in a direction that cooperates with a direction of extendibility to define an angle ranging from 30°-60°.

4. The grip as claimed in claim 3 wherein the angle is 45°.

5. The grip as claimed in claim 1 wherein the grip is extended circumferentially around the handle and makes a first side and a second side thereof have a connection therebetween, with the connection creating a seam line in accordance with a lengthwise direction of a handle.

6. The grip as claimed in claim 2 wherein the grip has a first side and a second side, with one of the first side and the second side extending circumferentially upward and the other of the first and the second sides extending circumferentially downward.

7. The grip as claimed in claim 3 wherein the grip has a first side and a second side, with one of the first side and the second side extending circumferentially upward and the other of the first and the second sides extending circumferentially downward.

8. A method for making a grip designed for a handle comprising:
preparing a sheet that has a quality of unidirectional extendibility;
trimming the grip from the sheet; and
extending the grip in a direction in accordance with a direction of extendibility for wrapping the handle.

9. The grip as claimed in claim 8 wherein the grip is trimmed in a direction in accordance with a direction of extendibility.

10. The method as claimed in claim 8 wherein the grip is trimmed in a direction that cooperates with a direction of extendibility to define an angle ranging from 30°-60°.

11. The method as claimed in claim 10 wherein the angle is 45°.

12. The method as claimed in claim 9 wherein the grip has a first side and a second side, with one of the first side and the second side extending circumferentially upward and the other of the first and the second sides extending circumferentially downward.

13. The method as claimed in claim 10 wherein the grip has a first side and a second side, with one of the first side and the second side extending circumferentially upward and the other of the first and the second sides extending circumferentially downward.

14. The method as claimed in claim 8 wherein the grip is extended circumferentially around the handle and makes a first side and a second side thereof have a connection therebetween, with the connection creating a seam line in accordance with the lengthwise direction of the handle.
